(19) United States
(12) Patent Application Publication
(10) Pub. No.: US 2009/0162544 A1
(43) Pub. Date: Jun. 25, 2009

(54) METHOD OF SURFACE COATING TO ENHANCE DURABILITY OF AESTHETICS AND SUBSTRATE COMPONENT FATIGUE

(76) Inventors: Carl E. Garesche, Kent, OH (US); Kellen M. Finn, Broadview Heights, OH (US); Joseph Hrabusa, Barberton, OH (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/961,560

(22) Filed: Dec. 20, 2007

(51) Int. Cl. B05D 1/36; B05D 3/00

(52) U.S. Cl. 427/202; 427/372.2; 427/299; 427/327

(57) ABSTRACT

A method for surface coating products, especially vehicle wheels, to improve the durability of their aesthetics and structural integrity via increased resistance to impact, abrasion, soil (e.g., brake dust), corrosion and fatigue stresses. The method comprises applying a uniform clear coating layer to the surface of the substrate, and then applying a preceramic resin film to the coated substrate, where the preceramic resin film is uniformly applied and cured onto the coated substrate so as to result in a ceramic shell of about 3 microns to about 12 microns in thickness over the coated substrate. In another embodiment, the method for the surface coating of an aluminum alloy substrate comprises applying a uniform clear coating layer to the surface of the aluminum alloy substrate and then applying a preceramic resin film to the coated aluminum alloy substrate, where the preceramic resin film is uniformly applied and cured onto the coated aluminum alloy substrate so as to result in a ceramic shell of about 3 microns to about 12 microns in thickness over the coated aluminum alloy substrate.

### BACKGROUND OF THE INVENTION

In one embodiment, the present invention relates to a method of surface coating to enhance the durability of aesthetics and substrate component fatigue of an article of manufacture. In another embodiment the invention pertains to a method for surface coating substrates useful in making structural members for numerous applications, such as automobile products, aerospace products, . . . etc., where the substrate product is made by any conventional manufacturing practice. In a further embodiment, this invention may also be applied to vehicle wheels that may be made from various types of materials.

Present surface treatments and coatings for metallic products typically involve a plurality of separate steps. The final painting step for many metallic products is a polymeric clear coat applied in either a powder or liquid form.

The desired end result of this inventive method is a coating that is hard to breach (impact resistant), hard to scratch (abrasion resistant), and through these attributes yields enhanced component fatigue performance while also providing greater durability of optical clarity to substrate and being easier to clean over longer periods of time than other surface treatments and coatings.

Thus, in one embodiment, the present invention discloses a method of surface treating and coating substrates useful in making structural members for numerous applications that has higher impact, abrasion, corrosion, soil and fatigue resistance, such as for aluminum wheel products. While surface treating and coating metallic substrates have been specifically discussed, such a method may also prove beneficial for use in other non-metallic applications.

### SUMMARY OF THE INVENTION

In one embodiment, the present invention provides a method for enhancing the durability of cosmetics and structural integrity of a substrate by improving the impact resistance, abrasion resistance, corrosion resistance, soil resistance and component fatigue performance of the substrate, especially vehicle wheels. The method comprises applying a uniform clear coating layer to the surface of the substrate and then applying a preceramic resin film to the coated substrate where the preceramic resin film is uniformly applied so as to result in a cured ceramic shell of about 3 microns to about 12 microns in thickness over the coated substrate. In another embodiment, the uniform clear coating layer may be cured onto the surface of the substrate either before the preceramic resin film is applied to the substrate or the uniform clear coating layer and the preceramic resin are simultaneously cured onto the substrate. In a farther embodiment, the surface of the substrate is pretreated before the uniform clear coating layer is applied to the surface of the substrate.

In one embodiment, the substrate is made of a metal such as aluminum, steel, magnesium or titanium alloy. In another embodiment, the substrate is a wheel product.

In another embodiment, the substrate is made of a composite material such as graphite, fiberglass or aramid.

In a further embodiment, the clear coating is an acrylic clear coat or a polyester clear coat. In one embodiment, the clear coat may be applied to the surface of the substrate in powdered form. In another embodiment the curing of the clear coating onto the surface of the substrate is at a temperature of about 350° F. for about 30 minutes.

In another embodiment, the preceramic resin film is a polysiloxane composition. In yet another embodiment, the preceramic resin film is a polysilazane composition. The preceramic resin film may be applied to the cured clear coated surface of the substrate by spray application. In a further embodiment, the curing of the preceramic resin film onto the clear coated surface of the substrate is at a temperature of about 180° F. for about four hours.

In yet another embodiment, the cured ceramic shell is about 3 microns to about 7 microns in thickness over the coated substrate. In another embodiment, the cured ceramic shell is about 4 microns to about 6 microns in thickness over the coated substrate. The substrate has a paint layer in another embodiment.

In yet a further embodiment, the present invention discloses a method for the surface treatment and coating of an aluminum alloy substrate, the method comprises applying a uniform clear coating layer to the surface of the aluminum alloy substrate and then applying a preceramic resin film to the coated aluminum alloy substrate, where the preceramic resin film is uniformly applied and cured onto the coated aluminum alloy substrate so as to result in a ceramic shell of about 3 microns to about 12 microns in thickness over the coated aluminum alloy substrate. In another embodiment, the uniform clear coating layer may be cured onto the surface of the aluminum alloy substrate either before the preceramic resin film is applied to the aluminum alloy substrate or the uniform clear coating layer and the preceramic resin are simultaneously cured onto the aluminum alloy substrate. In a further embodiment, the surface of the aluminum alloy substrate is pretreated before the uniform clear coating layer is applied to the surface of the aluminum alloy substrate.

Accordingly, it is one embodiment of the invention to provide a method of surface coating a vehicle wheel substrate to enhance corrosion resistance and component fatigue performance of the substrate.

It is another embodiment of the invention to provide a method of surface coating of a substrate to enhance corrosion resistance and component fatigue performance of the substrate.

It is yet another embodiment of the invention to provide a coating which is soil resistant and easy to clean.

These and other farther embodiments of the invention will become more apparent through the following description and drawing.

### BRIEF DESCRIPTION OF THE DRAWINGS

For a fuller understanding of the invention, reference is made to the following description taken in connection with the accompanying drawing(s), in which:

FIG. 1 is a flowchart depicting in one embodiment of the invention the detailed main steps of a coating method in accordance with the invention;

FIG. 2 is a schematic side view drawing depicting in another embodiment an aluminum alloy substrate treated with a conventional clear coated product;

FIG. 3 is schematic side view drawing depicting in a further embodiment the surface coating of a substrate treated in accordance with this invention; and

FIG. 4 is a schematic side view depicting in a further embodiment the surface coating of a substrate with a painted layer treated in accordance with the invention.

### DETAILED DESCRIPTION OF THE PREFERRED EMBODIMENTS

The present invention discloses a method of coating the surface of a substrate or an article of manufacture that results in improving component fatigue performance, impact resistance, abrasion resistance, soil resistance and corrosion resistance of a substrate. The method comprises applying a uniform clear coating layer to the surface of the substrate and then applying a preceramic resin film to the coated substrate, where the preceramic resin film is uniformly applied so as to result in a cured ceramic shell of about 3 microns to about 12 microns in thickness over the coated substrate. The preceramic resin film is cured into a ceramic shell onto the coated substrate. The substrate may be pretreated before the uniform clear coating layer is applied to the surface of the substrate.

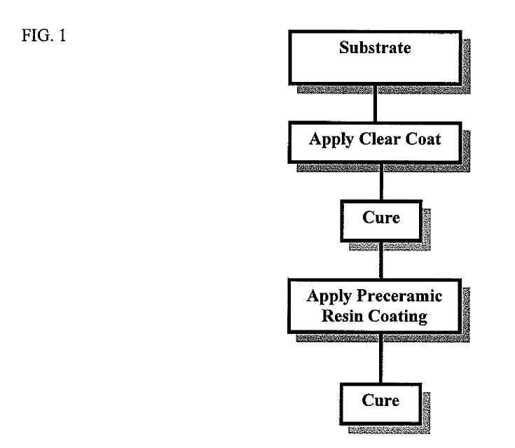

FIG. 1 shows a flow chart depicting in one embodiment of the invention the method steps in accordance with the present invention.

Here, the substrate is useful in making structural members for numerous applications, such as automobile products, aerospace products, . . . etc. The substrate may also be made of an aluminum alloy where the alloy substrate is made by forging, casting, rolling, extruding, or machining any of the aforementioned product forms, with or without joining practices into a sub-assembled or assembled structural component.

In another embodiment of the invention, the substrate may also be a vehicle wheel product that may be made from various types of materials such as, metals like aluminum, steel, magnesium, titanium, metal matrix composites and each of these have numerous different potential compositions, grades, etc. Also, in a further embodiment of the invention, composites like graphite, fiberglass and aramid (Kevlar®) could be pretreated and/or primed to accommodate the conventional clear or cosmetic and/or corrosion inhibiting coating and subsequent ceramic shell. In yet another embodiment, the types of vehicle wheels that could be coated with this technology includes automotive, truck, bus, RV, ATV, aircraft, trailer, motorcycle, agricultural/farm vehicles like tractors, industrial vehicles like cranes, earth movers, bulldozers, mining vehicles, . . . etc. There are also a multitude of wheel fabricating techniques e.g., casting, forging, multi-piece welded, cast and spun, forged and spun, steel casting, steel welded, and permutations of all of these techniques and more.

In general, a pretreatment depends on the substrate material to be coated. For aluminum, pretreatment may be limited to simple cleaning with solvents and/or detergents or soaps plus water, or may include numerous processes for cleaning, etching, chemical oxide conversion, anodizing, and/or surface treating such as by applying alkaline and/or acidic solutions to the substrate to be coated. The general purpose of a pretreatment is to provide for corrosion protection and/or to prepare the surface of the substrate to be coated so that the coating is able to evenly adhere to the substrate. Suitable types of solutions that may be used to pretreat an aluminum substrate include, but are not limited to, ALODINE 2600, ALODINE 5004 and ALODINE 4595 as sold by Henkel; DEOX as sold by Henkel Korea; GARDOBOND X4722 as sold by Chemetall; and NCC-2004 as sold by Angell MFG.

The conventional clear or cosmetic and/or corrosion inhibiting coating may be applied to the substrate either in powder or liquid form. In one embodiment, the coating is applied to the substrate by spraying in powder form for the present invention. The powder layer is then cured so that the powder particles melt and coalesce to form a continuous clear or cosmetic coating on the substrate. In another embodiment, the conventional clear or cosmetic and/or corrosion inhibiting coating may be applied to the substrate by being dipped, or brush applied in various ways. The types of conventional clear or cosmetic and/or corrosion inhibiting coatings used in the present invention are typically either acrylic clear or cosmetic coatings or polyester clear or cosmetic coatings.

Suitable types of acrylic clear or cosmetic coatings that may be used with the present invention include, but are not limited to, Clear Powder Topcoat 158C125, 158C123, CZ008Q and Acrylic Paint as sold by Akzo Nobel; 158C121 as sold by Akzo China; PCC10103, PCC10146 and DTM as sold by PPG; PCC10146 as sold by PPG Suzhou China; IF5000-LINE and IF-8000 sold by H. B. Fuller; ACE 2253 as sold by Seibert Power Coatings; and Vedoc® 90-60-0005-X, Vedoc® 90-60-0001-0, Corvel® 53-9025 and Corvel® 53-9012 as sold by Rohm and Haas Powder Coatings.

Suitable types of polyester clear or cosmetic coatings that may be used with the present invention include, but are not limited to, IF 3000-LINE, IF-4000-LINE, IF-5071 and TPE102 as sold by H. B. Fuller; Polyester Paints, Power Paint, JZ004U, VP188, 156C105 and 156C102 as sold by Akzo Nobel; PCT10107 as sold by PPG; PCTC10107 as sold by PPG Suzzhou China; and Vedoc® 4900080, Vedoc® 95-15-0001-0, Corvel® 33-9496 and Corvel® 33-9499 as sold by Rohm and Haas Powder Coatings. It may be further appreciated that colored, dyed, or otherwise pigmented coatings may be used or that an acrylic clear coating may be used over a colored paint. This further embodiment is shown in FIG. 4.

In one embodiment, the curing of these conventional clear or cosmetic and/or corrosion inhibiting coatings is performed at elevated temperatures for a period of time, such as approximately 350 degrees Fahrenheit for approximately 30 minutes. The specific parameters for curing may be based on the manufacturer's suggested practices for the exact coating product being used and may be modified within acceptable ranges of temperatures and times to avoid damaging either the underlying substrate and/or pretreatment and/or primer and/or paint coatings.

Suitable resins which can be used herein include, but are not limited to, preceramic resins such as polysilane, polycarbosilane, polysiloxane, polysilazane, polysiloxazane, polyureasilazane, poly(thio)ureasilazane and the like.

Suitable compositions are sold commercially by a number of manufacturers.

In another embodiment, preceramic resin chemistries are applied using finely dispersed droplets (spray application) rather than ionization in a vacuum. Control and dispersion of these droplets with state-of-the-art paint spraying methods achieves a preferred breakdown of constituent dispersions in the solvent. The end result is a light, highly transparent, “orange peel”-free film that can be cured into a durable shell. Applying a uniform preceramic film thickness is essential to achieving long-term performance of the desired properties—fatigue, impact abrasion, corrosion and soiling resistance. If the film is applied too thinly, impact resistance and corresponding fatigue performance are negatively impacted. Thickness inconsistency of a thin film can also yield variable fatigue enhancement and may expose the softer coating underneath as being susceptible to corrosion and soiling sites. If the preceramic film is applied too thickly, residual stresses developed during and after curing and cross-linking of the ceramic shell can lead to premature fissuring or cracking and ultimately loss of adhesion and separation over time.

The thickness of the cured ceramic shell is measured after application to a bare substrate utilizing a non-destructive method—such as is employed by the commercially available STRANDGAUGE® from Engineering Services International. The STRANDGAUGE® is designed to measure thin coatings, from about 0.0—to about 76.2 microns thick, by producing a capacitive output which is proportionally indicative of the coating thickness. It is an indirect measurement which must be scaled using a calibration sample—the coating thickness of the calibration sample is determined using a direct method like weight density. Computer control of the preceramic resin film application over a bare substrate, with subsequent measurement of the resultant cured ceramic shell via STRANDGAUGE®, ensures coating thickness control and repeatability when applied over the same wheel geometry with a previously applied clear coating over the substrate.

In one embodiment, the thickness of the cured ceramic shell is from about 3 microns to about 12 microns. In another embodiment, the thickness of the cured ceramic shell is from about 3 microns to about 7 microns. In a further embodiment, the thickness of the cured ceramic shell is from about 4 microns to about 6 microns.

A uniform preceramic resin film can not be achieved on parts with complex three dimensional surfaces, such as vehicle wheels, using conventional (e.g., manual) paint spraying methods. Precise control of the atomization or droplet size and droplet velocity is required, either with the use of electrostatic attraction force or via controlling pressurized air to accelerate droplets, or both. Additionally, full six degree of freedom robotic positioning of the applicator and simultaneous movement of the substrate about its geometrically similar axis is typically required to achieve a uniform preceramic resin film thickness. Subsequent to application, the preceramic resin film is then cured at room temperature or at an elevated temperature in an oven to form the ceramic shell.

Curing of these preceramic resins is typically performed at room temperature for a few days, or at elevated temperatures for a period of time, such as approximately 180 degrees Fahrenheit for approximately 4 hours, or approximately 250 degrees Fahrenheit for approximately 30 minutes. The specific parameters for curing may be based on the manufacturer's suggested practices for the exact preceramic resin product being used and may be modified within acceptable ranges of temperatures and times to avoid damaging either the underlying substrate and/or pretreatment and/or primer and/or paint and/or conventional clear or cosmetic and/or corrosion inhibiting coatings. Curing the preceramic resin at elevated temperatures for a period of time typically promotes a more complete conversion or cross-linking of the Si-groups to achieve the full potential hardness of the ceramic shell. This leads to optimum fatigue, impact, abrasion, corrosion and soiling resistance.

FIG. 2 shows a schematic side view drawing depicting an aluminum alloy substrate treated with a conventional clear corrosion inhibiting coating product.

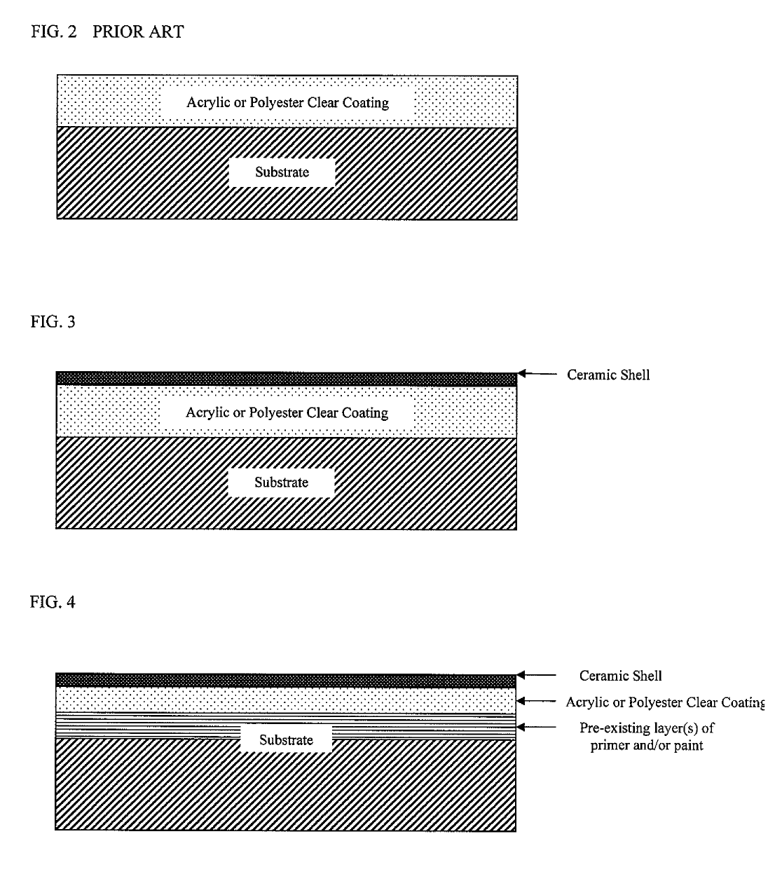

A schematic side view drawing depicting the surface coating of a substrate treated in accordance with this invention is shown in FIG. 3.

### EXAMPLE 1

Experimental articles have been successfully prepared utilizing the following methodology: clean, ALODINE 2600 based pretreat, dry, acrylic powder spray application to result in roughly 2 mils cured thickness, curing of acrylic clear coat at approximately 350 degrees Fahrenheit for about 30 minutes, cool, isopropanol clean the acrylic clear coating as needed, spray apply polysiloxane to result in roughly 5 microns cured thickness, followed by curing of the polysiloxane at approximately 180 degrees Fahrenheit for about 4 hours and then cooling to room temperature.

### EXAMPLE 2

Additional experimental articles have been successfully prepared utilizing the following methodology: clean, ALODINE 2600 based pretreat, dry, acrylic powder spray application to result in roughly 2 mils cured thickness, curing of acrylic clear coat at approximately 350 degrees Fahrenheit for about 30 minutes, cool, isopropanol clean the acrylic clear coating as needed, spray apply polysilazane to result in roughly 10 microns cured thickness, followed by curing of the polysilazane at approximately 250 degrees Fahrenheit for about 30 minutes and then cooling to room temperature.

Initial proof-of-concept gravelometer testing indicates a difference in the Point of Failure Notation between conventional pretreat with just a conventional acrylic clear coating, and the pretreated substrate of the present invention that has a conventional acrylic clear coating and subsequent polysiloxane-based ceramic shell. There are three categories for rating the “chipping” that results from gravelometer testing—the first is simply the number of chips. Here, the number of chips was rated higher/worse for the conventional substrate as compared to the substrate that included a ceramic shell of polysiloxane. The second category is the size of the chips, here there were bigger chips with a greater frequency for the conventional substrate as compared to the substrate that included a ceramic shell of polysiloxane. The third category is called “Point of Failure” and is further characterized by the “Level of Failure” and the “Failure Type”. For the standard treatment/coating, the “Level of Failure” included numerous large chips noted as “Substrate to Topcoat” with the corresponding “Failure Type” being “Adhesional”. For the substrate of the present invention, the “Level of Failure” was exclusively “Topcoat” only with corresponding “Failure Type” being exclusively “Cohesional”. This is important because adhesional substrate to topcoat chips expose bare metal that will necessarily result in accelerated corrosion and also fatigue resistance degradation due to the existence of stress concentrations in the surface of the component.

The Gravelometer testing is governed by the following specifications: SAE (Society of Automotive Engineers) SURFACE VEHICLE RECOMMENDED PRACTICE SAE J400 Revised November 2002 entitled, “Test for Chip Resistance of Surface Coatings”. And, ASTM (American Society for Testing and Materials) D3170-03 entitled, “Standard Test Method for Chipping Resistance of Coatings”.

This is a laboratory test that has been correlated with actual field results. The Scope section of the SAE Practice states that—“This SAE Recommended Practice covers a laboratory procedure for testing and evaluating the resistance of surface coating to chipping by gravel impact. The test is designed to reproduce the effect of gravel or other media striking exposed paint or coated surfaces of an automobile and has been correlated with actual field results.”

Coatings that are exposed to Gravelometer testing as being representative of field service impact resistance may also be tested with salt spray as being representative of field service corrosion resistance. ASTM (American Society for Testing and Materials) B117-03 entitled, “Standard Practice for Operating Salt Spray (Fog) Apparatus” governs industry accepted salt spray testing. Samples tested via Gravelometer may then be subjected to subsequent corrosion testing via 10 days of salt spray exposure in order to evaluate the potential combined effect of field service gravel impact and field service exposure to typical corrosive environmental influences.

Referring now to Table I there is shown the results of tests performed comparing fatigue specimens coated with a conventional clear coat and exposed to both Gravelometer and subsequent 10 days of Salt Spray to fatigue specimens coated with the present invention and exposed to both Gravelometer and subsequent 10 days of Salt Spray. The fatigue specimens are standard round bar specimens made from 6061 aluminum alloy and extracted from a production truck wheel forging. The fatigue testing was performed using a sinusoidal waveform at a frequency of 20-30 Hz, room temperature laboratory air (30-60% relative humidity) at a stress ratio of R=−1.0 and a maximum stress of 24 ksi—test conditions considered meaningful for differentiating the fatigue performance of this material. In connection with the baseline material coated with conventional clear coat and exposed to Gravelometer and subsequent 10 days of Salt Spray, characteristic specimen failure occurred at about 795,000 cycles. In connection with the baseline material coated with the present invention and exposed to Gravelometer and subsequent 10 days of Salt Spray, characteristic specimen failure occurred at about 1.367 million cycles. It is seen by comparing these test data that fatigue property improvements, equal to roughly seventy (70) percent for the characteristic life, were achieved by the present invention. Table I shows the test data. Chart 1 shows the Weibull analysis of the fatigue test results. The Weibull method is typically used to analyze fatigue results, especially when the sample size is small—even three or four failures. As seen in Chart 1, the slopes of the fatigue test results on the Weibull plot (Beta), are very similar for both populations, 1.84 for the conventional method and 1.78 for the method of the present invention. This confirms that both populations are comprised of a single failure mode and that the response or distribution of both populations is similar. Additionally, the Weibull plot shows that both sets of failure results fit a straight line indicating a high r² value for goodness of fit. The characteristic life, Eta, represents the typical or mean life of a specimen. The B10 life indicates the life at which 10% of the population will fail. Here the specimens coated with the present invention also showed a sixty-five (65) percent improvement in life.

TABLE I

| Specimen Type/Number | Cycles to Failure |
|---|---|
| Conventional/1 | 1,197 thousand |
| Conventional/2 | 672 thousand |
| Conventional/3 | 310 thousand |
| Conventional/4 | 566 thousand |
| Characteristic Life | 794 thousand |
| Present Invention/1 | 1,142 thousand |
| Present Invention/2 | 449 thousand |
| Present Invention/3 | 1,745 thousand |
| Present Invention/4 | 1,329 thousand |
| Characteristic Life | 1,367 thousand |

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method for treating a substrate, the method comprises:
applying a uniform clear coating layer to the surface of the substrate; and
then applying a preceramic resin film to the coated substrate,
wherein the preceramic resin film is uniformly applied and cured onto the coated substrate so as to result in a ceramic shell of about 3 microns to about 12 microns in thickness over the coated substrate.

2. The method of claim 1, wherein the surface of the substrate is pretreated before the uniform clear coating layer is applied to the surface of the substrate.

3. The method of claim 1, wherein after applying the uniform clear coating layer to the surface of the substrate, the clear coating layer is then cured onto the surface of the substrate.

4. The method of claim 1, wherein after applying the preceramic resin film to the coated substrate, the clear coating layer and the preceramic resin film are simultaneously cured onto the substrate.

5. The method of claim 1, wherein the substrate is made of a metal.

6. The method of claim 5, wherein the metal is selected from the group consisting of aluminum, steel, magnesium and titanium.

7. The method of claim 6, wherein the metal is a wheel product.

8. The method of claim 1, wherein the substrate is made of a composite material.

9. The method of claim 8, wherein the composite material is selected from the group consisting of graphite, fiberglass and aramid.

10. The method of claim 1, wherein the clear coating layer is an acrylic clear coat.

11. The method of claim 1, wherein the clear coating layer is a polyester clear coat.

12. The method of claim 10, wherein the acrylic clear coating layer is applied to the surface of the substrate in powdered form.

13. The method of claim 11, wherein the polyester clear coating layer is applied to the surface of the substrate in powdered form.

14. The method of claim 3, wherein curing of the clear coating layer onto the surface of the substrate is at a temperature of about 350° F. for about 30 minutes.

15. The method of claim 1, wherein the preceramic resin film is a polysiloxane composition.

16. The method of claim 1, wherein the preceramic resin film is a polysilazane composition.

17. The method of claim 3, wherein the preceramic resin film is applied to the cured clear coated surface of the substrate by spray application.

18. The method of claim 17, wherein the curing of the preceramic resin film onto the clear coated surface of the substrate is at a temperature of about 180° F. for about four hours.

19. The method of claim 1, wherein the ceramic shell is about 3 microns to about 7 microns in thickness over the coated substrate.

20. The method of claim 1, wherein the ceramic shell is about 4 microns to about 6 microns in thickness over the coated substrate.

21. The method of claim 1, wherein the substrate has a paint layer.

22. A method for the surface coating of an aluminum alloy substrate, the method comprises:
applying a uniform clear coating layer to the surface of the aluminum alloy substrate; and
then applying a preceramic resin film to the coated aluminum alloy substrate,
wherein the preceramic resin film is uniformly applied and cured onto the coated aluminum alloy substrate so as to result in a ceramic shell of about 3 microns to about 12 microns in thickness over the coated aluminum alloy substrate.

23. The method of claim 22, wherein the surface of the aluminum alloy substrate is pretreated before the uniform clear coating layer is applied to the surface of the aluminum alloy substrate.

24. The method of claim 22, wherein after applying the uniform clear coating layer to the surface of the aluminum alloy substrate, the clear coating layer is then cured onto the surface of the aluminum alloy substrate.

25. The method of claim 22, wherein after applying the preceramic resin film to the coated aluminum alloy substrate, the clear coating and the preceramic resin film are simultaneously cured onto the surface of the aluminum alloy substrate.
